(19) United States
(12) Patent Application Publication
(10) Pub. No.: US 2007/0028240 A1
(43) Pub. Date: Feb. 1, 2007

(54) Information processing method and information processing apparatus for processing a plurality of threads

(76) Inventor: Kouichi Hayakawa, Tokyo (JP)

Correspondence Address: KATTEN MUCHIN ROSENMAN LLP, 575 MADISON AVENUE, NEW YORK, NY, 10022-2585, US

(21) Appl. No.: 11/487,148

(22) Filed: Jul. 14, 2006

(30) Foreign Application Priority Data
Jul. 29, 2005 (JP) 2005-220427

(51) Int. Cl. G06F 9/46

(52) U.S. Cl. 718/100

(57) ABSTRACT

A user enters a signal requesting monitoring of information related to a thread. An operating system sets a stop flag at “1” in the thread. If the thread in which the stop flag is set is being executed by a processor, its context is saved in a main memory and the thread is placed in a stopped state. If the thread in which the stop flag is set is ready to transition to a running state, the thread is stopped without restoring its context in a register. The context saved in the main memory is displayed accordingly. In other cases, the thread is not stopped. When the monitoring by the user is completed, “0” is substituted into the stop flag so that the thread in a stopped state is restored for execution.

### BACKGROUND OF THE INVENTION

1. Field of the Invention

The present invention relates to an information processing technology and, more particularly, to an information processing method and an information processing apparatus for processing multiple threads in parallel.

2. Description of the Related Art

In the field of information processing, a technology for multithread system has recently been made available in which multiple processes are performed in parallel by dividing a task corresponding to a software application into a plurality of units of execution called threads, which are assigned to time slices available for a processor and are processed in sequence. A thread requires less management information than a task. As such, fewer steps are required for switching so that less overhead is incurred.

Multiple threads in a multithread system are scheduled to occupy respective time slices by an operating system (OS) which performs basic control in an information processing apparatus. A processor processes the threads according to the schedule. When a time slice assigned to a thread expires, the OS saves for later restoration the content of registers etc. which have been used in thread processing, placing the thread in a waiting state. The processor starts processing the next thread scheduled.

Meanwhile, a debugging task for detecting software defects and correcting a program accordingly is essential in marketing a software application as a product. For detection of a defect and proper correction of a program, it is necessary to cause a defect to manifest itself by running a software application in an actual execution environment. The contents of memories, registers, stacks etc. with which the threads are associated should be examined exhaustively, and timing information should be acquired indicating when a problem occurs in a variable etc., which is the result of operation, so as to identify a location in the program corresponding to the problem.

As described above, it is desirable in a debugging task to monitor a variable, etc. on a real-time basis in an actual execution environment. For example, a variable is monitored by stopping the process each time a block of a program has been executed. Alternatively, a break point is provided so that the process is stopped for monitoring of a variable when the break point is reached. We have recognized that stopping a single thread for monitoring of a variable, etc, in a multithread system as described above results in a monitored result different from the actual execution environment, because multiple threads are processed under the control of the OS as they interfere with each other in respect of their order of execution and the use of registers and memories. As a result, real-time monitoring required in debugging is hard to achieve.

### SUMMARY OF THE INVENTION

A general purpose of the present invention is to provide a technology adapted to a multithread system whereby it is possible to debug a program in an environment close to the actual execution environment.

An information processing method according to at least one embodiment of the present invention comprises; accepting a signal requesting monitoring of internal information related to a thread; writing, in relation to the monitored thread, flag information indicating that the signal is input in a table which stores information indicating the state of a thread; and outputting the internal information in accordance with the signal, wherein the table is referred to before processing a thread and, when the flag information is detected, prescribed restriction is imposed on the process of the thread.

A “thread” is an application programmed to achieve a purpose or the substance of information processing included in the application. As such, a thread may correspond to an application or a unit smaller than an application such as I/O control and a user-specified command. The essence is that a thread corresponds to a unit of certain process or function. The phrase “internal information” refers to any information indicating the processing state in the information processing apparatus. For example, it may refer to a variable generated in the process of running a thread, the order of execution of multiple threads, the order of threads in wait for an input and output device connected to the information processing apparatus, or the state of the thread.

An information processing method according to at least one embodiment of the present invention comprises: accepting a signal requesting monitoring of internal information related to a thread; monitoring whether the monitored thread is set to start transitioning to a state in which the monitored thread is executed by a processor; outputting internal information related to the monitored thread which is not set to start transitioning; and placing the monitored thread which is set to start transitioning in a stopped state.

An information processing apparatus for processing a plurality of threads by a processor according to at least one embodiment of the present invention, comprises: a storage which stores a state information table maintaining information on a thread; a request accepting unit which accepts a user input of a signal requesting monitoring of internal information related to a thread; an information updating unit which writes, in relation to the monitored thread, flag information indicating that the signal is input in the state information table; an authorization unit which refers to flag information in the state information table before processing a thread so as to determine whether the process of the thread should be started; and a state output unit which outputs the internal information in accordance with the signal.

Optional combinations of the aforementioned constituting elements, and implementations of the invention in the form of methods, apparatuses, systems computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the structure of an information processor according to an embodiment of the present invention;

FIG. 2 schematically shows state transitions of threads;

FIG. 3 is a flowchart showing a procedure for displaying information related to a monitored thread in this embodiment; and

FIG. 4 shows the structure of a management information table for threads according to the embodiment.

### DETAILED DESCRIPTION OF THE INVENTION

The invention will now be described by reference to the preferred embodiments. This does not intend to limit the scope of the present invention, but to exemplify the invention.

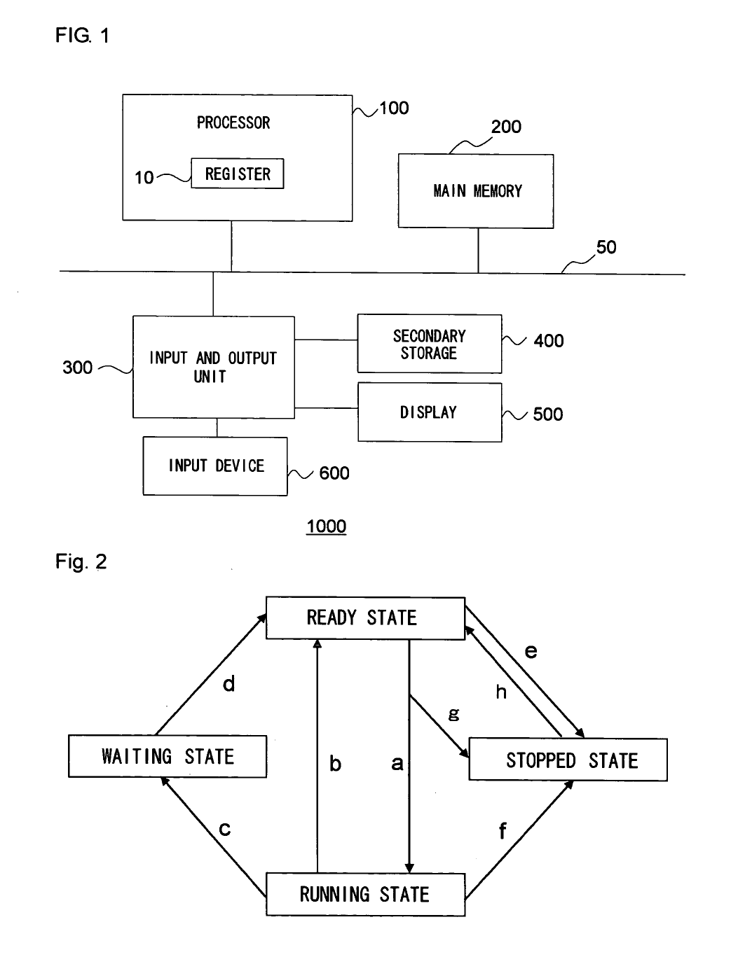

FIG. 1 is a block diagram showing the structure of an information processor 1000 according to an embodiment of the present invention. The information processor 1000 includes a processor 100, a main memory 200 and an input and output unit 300, which are connected to each other via a bus 50. The input and output unit 300 is connected to a secondary storage 400, a display device 500 and an input device 600 such as a keyboard. The elements illustrated in FIG. 1 as functional blocks executing respective processes are implemented hardwarewise by a CPU, a memory, an LSI, etc. and softwarewise by a program provided with reservation and management functions and loaded into the memory. Therefore, it will be obvious to those skilled in the art that the function blocks may be implemented in a variety of manners including hardware only, software only or a combination of both.

On the information processor 1000, an operating system (OS) for integrated control is run that provides functions and environments to enable efficient utilization of the information processor 1000. Multiple software applications (hereinafter, simply referred to as applications) are run on the operating system.

The processor 100 processes multiple threads created by the application run on the information processor 1000 according to a schedule generated by the operating system by referring to processing time, priority, etc. The threads processed use a register 10 in the processor 100 as a temporary storage area and temporarily stores operation results, etc. therein.

The main memory 200 is a storage area comprising a dynamic random access memory (RAM) and storing machine code programs and data corresponding to the application being run. The main memory 200 is used to store a stack used by a thread processed by the processor 100 or used by a thread in a “waiting” state to temporarily save the content of the register 10 used when the thread was being processed.

The input and output unit 300 outputs data to the secondary storage 400 (hard disk, CD-ROM or the like), the display 500, etc. under the control of the processor 100. The input and output unit 300 also receives data, signals, etc. from the secondary storage 400 and the input device 600 so as to deliver the input to the processor 100 and the main memory 200.

A description will now be given of a procedure whereby multiple threads generated are processed in the information processing apparatus 1000.

FIG. 2 schematically shows state transitions of threads. “Running” denotes a state in which a thread is being processed by the processor 100. “Ready” denotes a state in which a process is enabled and the thread stands by for transition to “running”. “Waiting” denotes a wait state in which the thread waits for something other than the process by the processor 100. For example, it denotes a state in which the thread waits to gain access to the main memory 200. “Stopped” denotes a state in which the thread exits a loop for some reason and is stopped. A management information table stored in the main memory 200 describes the state in which a thread is, in relation to identification information of the thread. The OS determines the state of the threads by referring to the management information table. Further, the OS controls the state transition of the threads based upon information such as priority or processing time of the threads.

For example, the OS schedules threads in a “ready” state according to a prescribed scheme, based upon processing time, priority, etc. A thread in a “running” state releases the processor 100 as a result of consuming the time slice assigned to the thread or as a result of automatic suspension of the process, transitioning from a “running” state to a “ready” state or a “waiting” state (transition b and transition c, respectively). When this occurs, the next thread scheduled for processing transitions from a “ready” state to a “running” state (transition a), whereupon the processor 100 processes the thread.

In a multithread system, multiple threads within the same process are allowed to access common data. The OS subjects the threads to exclusive control to prevent a trouble from occurring as a result of writing or reading the same data at the same time. For this purpose, when a thread attempts to access a unit locked by another thread, the accessing thread is blocked and is placed in a “waiting” state. More specifically, if a thread accesses a unit other than the processor 100, such as the main memory 200, the secondary storage 400, the display 500, the input and output device 600, etc., and if the accessed unit is locked by another thread, the accessing thread is placed in a “waiting” state until the unit is released. If still another thread requires access to the unit, then an access queue is created in a “waiting” state for access to the unit. This mechanism is implemented by tools for synchronization such as mutex and semaphore provided by an OS compatible with a multithread system.

Furthermore, a thread is placed in a “waiting” state when it waits for a response signal from another thread or from an input and output device, or when it waits for time-out of a timer for execution of the thread triggered by the occurrence of a cyclic event. As in the case of access to the same unit, the multiple threads in a “waiting” state in wait for a response signal from the same originator forms a queue in wait for the signal.

A thread in a “waiting” state transitions to a “ready” state (transition d) when the factor producing the “waiting” state is removed as a result of, for example, the unit desired to be accessed is released by another thread. The thread that has completed the transition is subject to scheduling. If a queue is formed, the threads in the queue transition to a “ready” state one by one, with the thread at head of the queue transitioning first and then followed by the others.

When a thread in a “running” state transitions to a “waiting” state or a “ready” state, context switch is performed. Information related to the process (hereinafter, referred to as a context), such as the results of operation etc. that were stored in the register 10 and used to process the thread, are saved in the main memory 200. When the thread is placed in a “running” state again, the information is read from the main memory 200 and restored in a storage area such as the register 10, allowing the thread to be processed again.

We shall consider a case of debugging a source code constituting a thread (hereinafter, such a thread will be referred to as a monitored thread). According to related-art debugging, the context such as a variable owned by the monitored thread is monitored by enforcing the transition of the monitored thread from a “running” state or a “ready” state to a “stopped” state (transition f and transition e) by a user input signal. For this purpose, a generally known technology for interrupt is employed. More specifically, the monitored thread is transitioned to a “stopped” state by issuing an interrupt signal to stop the process of the monitored thread in a “running” state and to store the context in the memory 200. Subsequently, an opportunity is given to the user to identify the location of a defect by displaying the source code or the context stored in the main memory 200 on the display device 500. When the monitoring activity by the user is completed, the monitored thread is transitioned from a “stopped” state to a “running” state, and the context is restored so that the process is resumed. Other methods of debugging include providing a break point in the source code so that the thread is transitioned to a “stopped” state in a similar process when the process reaches the break point.

The above-mentioned approach poses a challenge in that it is difficult to preserve the actual execution environment by placing a monitored thread undergoing a cycle of state transition to a “stopped” state. For example, given that the context of a thread in a queue in wait for the release of a unit is to be monitored, forcing the transition of the thread to a “stopped” state brings about a change in the order of threads in the queue. If a subsequent thread in the queue gains access to the target unit and is placed in a “ready” state or a “running” state while the monitored thread retrieved from the queue remains in a “stopped” state, it is no longer possible to restore the monitored thread to its original state. Since the process proceeds such that the multiple threads within the same process access common data as they interfere with each other, the change in the order of threads in the queue may affect the result of processes in other threads. Unless the order in the queue is preserved, it may also be difficult to monitor the queue itself.

As described above, the context of a thread in a “waiting” state or a “ready” state is saved in the main memory 200. Therefore, it will theoretically be possible to monitor the thread without placing the thread in a “stopped” state. Meanwhile, the factor that forced the wait may be resolved while the thread is being monitored, causing the thread to transition to a “running” state. This causes the context to be restored in the register 10, overwriting the old context, with the result that the context being monitored is old information. If the thread that caused the overwriting transitions again to a “waiting” state or a “ready” state, conflict may occur between a resultant access to a context saving area in the main memory 200 and the access for the monitoring. The embodiment described below is a culmination of our efforts to resolve the above-mentioned problem.

In this embodiment, if a user gives an instruction to monitor information related to a thread, a stop flag is set in the monitored thread. When the thread in which a stop flag is set is in a “running” state or is in the process of transitioning to a “running” state, the thread is transitioned to a “stopped” state (transition f and transition g). If a stop flag is set in a thread in the process of transitioning from a “ready” state to a “running” state (transition a), the thread is transitioned to a “stopped” state immediately after the thread transitions to a “running” state (transition f). If a stop flag is set in a thread in a “ready” state or “waiting” state, the thread is transitioned to a “stopped” state when the time has come to transition from a “ready” state to a “running” state (transition g).

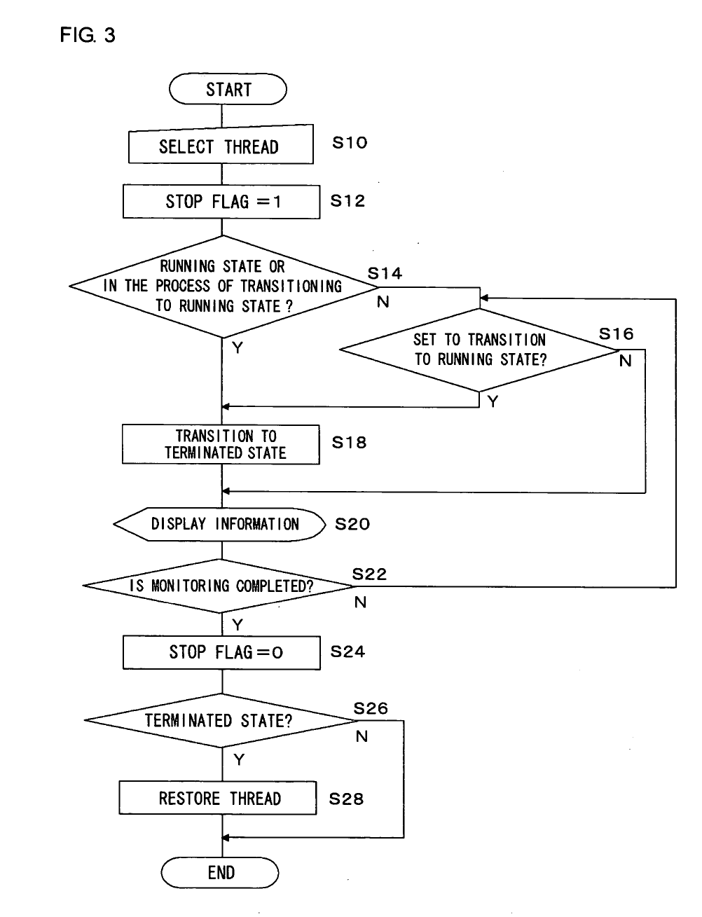

FIG. 3 shows a procedure for displaying information related to a monitored thread in this embodiment. First, a user calls software such as a debugger. The software may be a package stored in the secondary storage 400 or may be included in the kernel of the OS started. Instruction to display the information on the monitored thread is given via the input device 600, by selecting from a thread list displayed on the display 500 (S10). The OS sets a stop flag in the monitored thread thus selected (S12). The stop flag is a variable in a construct constituting a management information table stored in the main memory 200 for the kernel to track and control the state of threads. Normally, “0” is substituted into the variable. In S12, the flag is set by substituting “1” into the variable. The structure of the management information table will be described later.

A determination is then made as to whether the monitored thread in which the stop flag is set is in a “running” state or is in the process of transitioning to a “running” state, by referring to the thread state stored in the management information table (S14). The phrase “in the process of transitioning” indicates a state in which a monitored thread is in a queue in a “ready” state and its turn to be processed by the processor 100 has arrived. Such a state starts when the previous thread, having been processed by the processor 100, releases the processor 100 and ends when the context is completely restored in the register 10 to resume the execution of the monitored thread. If the monitored thread is in a “running” state or in the process of transitioning to a “running” state (Y in S14), the context is saved in the main memory 200 and the thread is transitioned to a “stopped” state (S18). If the thread is in a “running” state, the process of the thread by the processor 100 is stopped before transitioning the thread to a “stopped” state. If the thread is in the process of transitioning to a “running” state, the system waits until the context is completely restored in the register 10 before transitioning the thread to a “stopped” state.

If the monitored thread is not in a “running” state or in the process of transitioning to a “running” state (N in S14), a determination is made as to whether the thread is set to start transitioning to a “running” state (S16). If the thread is set to start transitioning to a “running” state (Y in S16), the thread is transitioned to a “stopped” state without restoring the context in the register 10 (S18). Control exercised in S16 may be such that, each time a thread in a “running” state releases the processor 100, the thread scheduled to transition to a “running” state is monitored for a stop flag. If a stop flag is set, the thread is transitioned to a “stopped” state.

After the monitored thread is transitioned to a “stopped” state (S18), or when the monitored thread is in a “waiting” state or a “ready” state (N in S16), the information such as the context of the thread saved in the main memory 200 is read by the input and output unit 300 and displayed on the display 500 (S20). The information is displayed continuously, with monitoring whether the monitored thread transitions to a “running” state, until the OS recognizes the termination of the monitoring, by detecting, for example, a user input of a termination instruction in the input device 600 (N in S22). When the OS recognizes the termination of investigation (Y in S22), the OS substitutes “0” in the stop flag set in the monitored thread (S24). If the monitored thread has been in a “stopped” state for monitoring because the thread was in a “running” state or in the process of transitioning to a “running” state previously (Y in S26), the thread is restored from the “stopped” state (S28). For restoration, the monitored thread is given a relatively high priority before returning it to the queue in a “ready” state (h in FIG. 2) so that the thread is transitioned to a “running” state next time the processor 100 is released. If the monitored thread is in a state other than a “stopped” state (i.e. if the thread is in a “waiting” state or a “ready” state) (N in S26), the order in the queue is preserved while the thread information is being displayed. Therefore, the monitoring can end without taking extra measures.

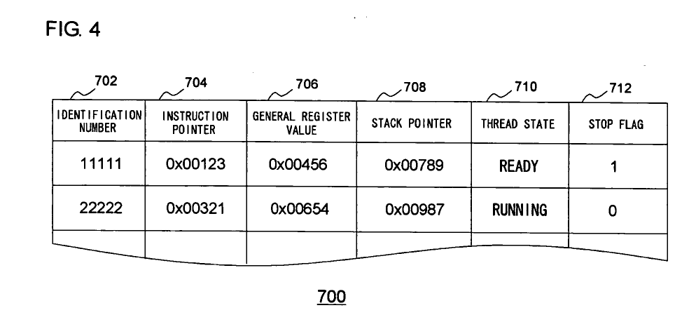

FIG. 4 shows the structure of a management information table for threads according to the embodiment. A management information table 700 includes an identification number column 702, an instruction pointer column 704, a general register value column 706, a stack pointer column 708, a thread state column 710 and a stop flag column 712. The threads are managed according to identification numbers entered in the identification number column 702. The instruction pointer column 704 stores a pointer indicating the address in the register 10 storing a machine code command executed by the thread. The general register value column 706 stores the current value of the general register. The stack pointer column 708 stores the pointer indicating the address in the stack area assigned to the thread. These columns are referred to in context switching. A character string identifying the current state of the thread (e.g. “ready” or “running”) is entered in the thread state column 710. For example, the entry in the thread state column 710 is referred to in S14 or S16 of FIG. 3 to monitor the state of the thread in which the stop flag is set. As already mentioned, “1” is entered in the stop flag column 712 if the thread is a monitored thread. Otherwise, “0” is entered in the stop flag column 712.

Items other than those shown in FIG. 4 may be included in the management information table 700. For example, the values in an integer register and a floating-point register may be stored as the general register value. Alternatively, the value in a register used as a function setting register may be maintained in the table. The stack pointer maintained in the table may comprise pointers for a kernel stack and a user stack. Further, flags other than the stop flag may be maintained in the table. For example, flags used to manage threads, such as a flag indicating whether the thread waits for another thread at the end of its execution, a flag indicating whether the thread is an interrupt thread or an ordinary thread, or a flag indicating whether the thread is a kernel thread or a user thread.

According to the embodiment, information such as the context can be monitored without transitioning a monitored thread in a “waiting” state to a “stopped” state. Thus, it is possible to acquire information on threads as they are actually being run without changing the order of the threads in a queue. The process related to the queue can be resumed once the monitoring is completed. Therefore, the process can proceed until the next monitoring without affecting the execution environment. Since it is ensured that the monitored thread does not transition to a “running” state while the context saved in the main memory 200 is being displayed, there is no trouble such as incompatibility between the actual situation and the information displayed. Accordingly, integrity in the monitoring activity is ensured. While the monitoring proceeds, the order of threads in a queue in a “waiting” state or a “ready” state is preserved. Therefore, information related to the order of threads in a queue itself can be displayed. This enables the user to monitor the information related to the threads in an environment close to the actual execution environment and to decisively identify an area causing a trouble. Consequently, efficient debugging is facilitated.

The description of the invention given above is based upon an embodiment. The embodiment described is only illustrative in nature and various variations in constituting elements and processes involved are possible. Those skilled in the art would readily appreciate that such variations are also within the scope of the present invention.

For example, the software that implements the present invention may be stored in a server (not shown) connected to the information processing apparatus 1000 via the network so that the inventive process is performed over the network. This allows debugging with an actual device to be efficiently performed in an information processing apparatus which is not provided with debugging software.

Multiple threads may be designated as monitored threads so that a stop flag is set in the threads. For example, by setting a stop flag in all the threads generated, threads transitioning from a “ready” state to a “running” state are transitioned to a “stopped” state without exception. When the monitoring is completed, the threads are returned to the head of the queue in a “ready” state in the order that the threads transitioned to a “stopped” state. With this, monitoring can take place while preserving the order of execution in a “running” state. Thus, debugging in an environment close to the actual execution environment is achieved.

What is claimed is:

1. An information processing method comprising;
accepting a signal requesting monitoring of internal information related to a thread;
writing, in relation to the monitored thread, flag information indicating that the signal is input in a table which stores information indicating the state of a thread; and
outputting the internal information in accordance with the signal, wherein
the table is referred to before processing a thread and, when the flag information is detected, prescribed restriction is imposed on the process of the thread.

2. The information processing method according to claim 1, wherein the prescribed restriction includes non-permission of the start of the process of the thread.

3. The information processing method according to claim 1, wherein the internal information includes information related to the order in a queue which contains a plurality of threads including the monitored thread in wait for execution.

4. The information processing method according to claim 1, wherein the internal information includes information related to the order in a queue which contains a plurality of threads including the monitored thread in wait for access to an input and output device.

5. The information processing method according to claim 1, further comprising stopping the process by saving the context related to the monitored thread in a main memory, if the monitored thread is being processed when the signal is input.

6. The information processing method according to claim 5, wherein, when the internal information has been output, the monitored thread for which the process is stopped is given a prescribed priority before being placed in a queue in wait for execution.

7. An information processing method comprising:
accepting a signal requesting monitoring of internal information related to a thread;
monitoring whether the monitored thread is set to start transitioning to a state in which the monitored thread is executed by a processor;
outputting internal information related to the monitored thread which is not set to start transitioning; and
placing the monitored thread which is set to start transitioning in a stopped state.

8. An information processing apparatus for processing a plurality of threads by a processor, comprising:
a storage which stores a state information table maintaining information on a thread;
a request accepting unit which accepts a user input of a signal requesting monitoring of internal information related to a thread;
an information updating unit which writes, in relation to the monitored thread, flag information indicating that the signal is input in the state information table;
an authorization unit which refers to flag information in the state information table before processing a thread so as to determine whether the process of the thread should be started; and
a state output unit which outputs the internal information in accordance with the signal.

9. The information processing apparatus according to claim 8, wherein the authorization unit imposes prescribed restriction on the process of the thread when the flag information is detected in the state information table.

10. The information processing apparatus according to claim 8, wherein the storage includes a storage area which saves, when a thread being processed transitions to a queue, the context related to the thread from a register, and wherein the state output unit outputs at least a part of the context of the monitored thread in a queue saved in the storage area.

11. The information processing apparatus according to claim 10, wherein the state output unit outputs information related to the order in the queue to which the monitored thread belongs.

12. The information processing apparatus according to claim 8, further comprising a state controller which stops the execution of the monitored thread if the monitored thread is being processed when the signal is input, by saving the context related to the monitored thread from a register to a storage area included in the storage, wherein the state output unit outputs internal information related to the monitored thread for which the execution is stopped by the state controller.

13. The information processing apparatus according to claim 12, wherein the state controller, after outputting the internal information related to the monitored thread for which the execution is stopped, gives the monitored thread a prescribed priority before placing the monitored thread in a queue in wait for execution.

14. A computer program product comprising:
an accepting module which accepts a signal requesting monitoring of internal information related to a thread;
a writing module which writes, in relation the monitored thread, flag information indicating that the signal is input in a table maintaining state information indicating the state of a thread;
a restriction module which refers to the table before processing a thread and, when the flag information is detected, imposes prescribed restriction on the process of the thread; and
an outputting module which outputs the internal information in accordance with the signal.

15. A recording medium which embodies thereon a computer program product, the computer program product comprising:
an accepting module which accepts a signal requesting monitoring of internal information related to a thread;
a writing module which writes, in relation the monitored thread, flag information indicating that the signal is input in a table maintaining state information indicating the state of a thread;
a restriction module which refers to the table before processing a thread and, when the flag information is detected, imposes prescribed restriction on the process of the thread; and
an outputting module which outputs the internal information in accordance with the signal.
